(19) United States
(12) Patent Application Publication
(10) Pub. No.: US 2022/0036317 A1
(43) Pub. Date: Feb. 3, 2022

(54) System and Method for Confluence Resource Allocation

(71) Applicant: Hubstar International Limited, London (GB)

(72) Inventors: Stefanos Vatidis, London (GB); Denis Mequinion, London (GB)

(21) Appl. No.: 16/944,709

(22) Filed: Jul. 31, 2020

(51) Int. Cl. G06Q 10/10; G06F 9/50; G06Q 10/06

(52) U.S. Cl. CPC G06Q 10/1095; G06F 9/5005; H04N 7/15; G06F 2209/5013; G06Q 10/06315

(57) ABSTRACT

A computer-implemented method including: receiving a request to schedule a confluence involving a plurality of entities during a future time interval, wherein the confluence is associated with one or more confluence locations; obtaining a plurality of expected location indicators, wherein the plurality of expected location indicators indicate the expected location of the plurality of entities during the future time interval; and allocating resources for the confluence during the future time interval based on the plurality of expected location indicators.

### TECHNICAL FIELD

The present disclosure relates to systems and methods for allocating resources for confluences. In particular, but without limitation, this disclosure relates to systems and method for allocating resources for confluences of participants distributed across multiple locations.

### BACKGROUND

Confluence-scheduling systems facilitate scheduling confluences (e.g. meetings) during a future time interval based on input from a confluence host and/or confluence attendees. Existing confluence-scheduling systems require an undesirably high amount of user input. Furthermore, these existing confluence-scheduling systems leave a significant amount of useful data unutilized resulting in suboptimal choices of future time periods at which to schedule confluences. These suboptimal choices may result in changes being required to the chosen future time periods for the confluences based on attendee feedback. Communicating such changes to attendees consumes both network bandwidth and computational resources. Furthermore, such changes increase the likelihood of required attendees unintentionally missing the confluence resulting in the impromptu cancellation of the confluence wasting both attendee time as well as resources allocated for the cancelled confluence.

These existing systems may also not facilitate allocation of suitable equipment and locations for the confluence increasing the likelihood that such suitable equipment and locations will not be available for the confluence. Therefore, there is an even greater likelihood of changes being required to the chosen future time periods for the confluence as well as impromptu cancellations due to the unavailability of suitable equipment and/or locations where such equipment and/or locations are required. Thus, further network bandwidth and computational resources may be wasted.

The above problems are exacerbated when scheduling confluences of participants distributed across multiple locations due to at least a requirement to facilitate telecommunication between the multiple locations.

### SUMMARY

Aspects described herein improve allocation of resources for confluences (e.g. meetings, telephone calls, video calls, etc.) of entities by utilizing data relating to one or more of the confluence entities. These improvements in the allocation of resources for confluences may result in decreased user input, and fewer reschedulings and impromptu cancellations of confluences. Processing user input, and communicating reschedulings and impromptu cancellations of confluences consume network bandwidth and computational resources. Thus, reducing these reduces the consumption of network bandwidth and computational resources.

According to a first aspect, there is provided a computer-implemented method. The provided computer-implemented method includes: receiving a request to schedule a confluence involving a plurality of entities during a future time interval; obtaining a plurality of expected location indicators; and allocating resources for the confluence during the future time interval based on the plurality of expected location indicators. The confluence may be associated with one or more confluence locations. The plurality of expected location indicators may indicate the expected location of the plurality of entities during the future time interval.

Allocating resources for the confluence during the future time interval based on the expected location indicators increases the likelihood that the resources allocated for the confluence are appropriate for the expected location of the entities of the confluence, e.g. resources are allocated for the entities at or for the correct expected location. This prevents or at least reduces reschedulings and/or impromptu cancellations of the confluence, and, hence, prevents or at least reduces communications of such reschedulings and/or impromptu cancellations, and/or reallocations of resources for the rescheduled confluence. As such communications and reallocations consume network bandwidth and computational resources, the consumption of network bandwidth and computational resources are correspondingly reduced.

A requested confluence can be any event (e.g. a meeting, discussion, telephone call, video conference discussion, etc.) over a future time period during which each of the plurality of entities is requested to be available. Attendance of the event may be requested for each of the plurality of entities. Attendance may require physical attendance or remote attendance (e.g. via remote communication, such as a telephone or network connection).

Allocating resources for the confluence may include determining a future time period for the confluence within the future time interval.

Accordingly, a future time period may be allocated for the confluence, wherein the future time period falls within the requested future time interval. The request may therefore define a range of time (the future time interval) during which the confluence is requested to be scheduled. The future time period may be unbounded on one side (e.g. the future time period may be defined as any time later than an initial time).

Determining a future time period for the confluence within the future time interval allows a broader range of time to be defined by an entity requesting the confluence, which can then be narrowed to a more particular future time period taking into account external factors such as expected location indicators. This allows the entity requesting the confluence to specify a preferred range of time during which the confluence may be scheduled. This helps to prevent or at least reduce the likelihood that the future time period allocated for the confluence is inappropriate. Therefore, reschedulings and/or impromptu cancellations of the confluence may be reduced, and hence, consumption of network bandwidth computational resources reduced for the reasons previously given.

Determining the future time period for the confluence may include: determining one or more suggested future time periods for the confluence within the future time interval; and sending, to a client device of a host entity of the plurality of entities, the one or more suggested future time periods.

Sending one or more suggested future time periods for the confluence to the client device of the host entity provides the host entity the opportunity to select an appropriate future time period for the confluence.

The one or more suggested future time periods may be determined based on an availability of one or more of the plurality of entities within the future time interval.

Determining the suggested future time periods based on the availability of one or more of the plurality of entities may increase the likelihood that the suggested future time periods are future time periods where the one or more of the plurality of entities are available, and, hence, facilitate the host entity in determining an appropriate future time period for the confluence.

The one or more suggested future time periods may be determined based on an importance of one or more of the plurality of entities. Determining the suggested future time periods based on an importance of one or more of the plurality of entities may increase the likelihood that the suggested future time periods are future time periods appropriate for more important entities of the plurality of entities, e.g. VIP or required entities, hence, facilitating the host entity in determining an appropriate future time period for the confluence. A level of importance may be allocated to each entity, either as specified in the request to schedule the confluence (e.g. as set by a requesting entity) or predefined and associated with each entity (e.g. a predefined level of importance within a group or organisation).

The one or more suggested future time periods for the confluence may include the future time period, and determining the future time period for the confluence may include receiving, from the client device of the host entity, a selection of the future time period from the one or more suggested future time periods.

Using a suggested time period selected by the host entity further increases the likelihood that the future time period is appropriate as both the suggestions and the manual input of the host entity are available for determining the future time period. Therefore, reschedulings and/or impromptu cancellations of the confluence may be prevented and/or reduced, and hence, consumption of network bandwidth and computational resources reduced for the reasons previously given.

Determining the future time period for the confluence may include: receiving, from the client device of the host entity, a selection of the one or more suggested future time periods as a plurality of time period options; sending, to the client devices of one or more attendee entities, at least a subset of the plurality of time period options; and receiving, from at least one of the client devices of the one or more attendee entities, selections of one or more of the at least a subset of the plurality of time period options.

Using selections of suggested time periods as time period options by the host entity and selections of these time period options by one or more attendee entities in determining the future time period further increases the likelihood that the future time period is appropriate as the suggestions, manual input from the host entity and manual input from attendee entities are available for are available for determining the future time period.

The at least a subset of the plurality of time period options sent to the client device of a respective entity may be based on an importance of the respective entity.

Basing the at least a subset of the plurality of time period options on the importance of the respective entity may prevent or at least reduce the sending of irrelevant time period options being sent to the respective entity, and, hence the unnecessary consumption of network bandwidth and computational resources in sending these irrelevant time period options.

The time period options may include the future time period, and determining the future time period for the confluence may include determining, based on the selections of the one or more of the at least a subset of the plurality of time period options, that the future time period is a best time period of the plurality of time period options.

The best time period may be an optimum time period. Determining that the future time period is the best future time period based on the selections further increases the likelihood that the future time period is appropriate as the suggestions, manual input from the host entity and manual input from attendee entities are utilized in determining the future time period. Therefore, reschedulings and/or impromptu cancellations of the confluence may be prevented and/or reduced, and hence, consumption of network bandwidth and computational resources reduced for the reasons previously given. Furthermore, determining the best future time period based on the selections prevents or at least reduces the need for further manual input from entities, e.g. further manual input from the host entity, saving network bandwidth and computational resources associated with processing this further manual input.

Determining the future time period for the confluence may include sending, to the client device of the host entity, the selections of the one or more of the at least a subset of the plurality of time period options; and receiving, from the client device of the host entity, one or more amended time period options. The one or more amended time period options may include the future time period.

The ability to use one or more amended time period options as the future time period facilitates continued use of the manual input previously received from the host entity and the one or more attendee entities in the determination of the future time period, even in circumstance where the unamended time period options did not include the future time period. Thus, recollection and/or reprocessing of this data is prevented or at least reduced, and the network bandwidth and computational resources which would be consumed by this recollection and/or reprocessing saved.

Allocating resources for the confluence may include allocating, at the future time period, a precise confluence location for the confluence within a general confluence location of the one or more confluence locations.

A general confluence location may be a larger region than the precise confluence location. The general confluence location may be an office, building or region whilst a precise confluence location may be a specific room, desk or area within the general confluence location. The precise confluence location may be determined based on a utilization schedule for the precise confluence location (i.e. a schedule of already scheduled confluences for the precise confluence location). Allocating a precise confluence location within the general confluence location prevents or at least reduce the likelihood that a precise confluence location within the general confluence location is unavailable for the confluence at the future time period. Thus, reschedulings and/or impromptu cancellations caused by the unavailability of a precise confluence location may be prevented or at least reduced, so consumption of network bandwidth and computational resources may be reduced for the reasons previously given.

Allocating the precise confluence location may include: determining, based on the plurality of expected location indicators, the number of the plurality of entities that are expected to be proximate to the general confluence location at the future time period; and allocating, at the future time period, the precise confluence location based on the number of the plurality of entities. The precise confluence location may have an entity capacity greater than or equal to the number of the plurality of entities.

Allocating a precise confluence location based on the number of the plurality of entities that are expected to be proximate to the general confluence location at the future time period, with the precise confluence location having a capacity greater than or equal to the number of entities, increases the likelihood that the allocated precise confluence location will be appropriate for the confluence and can be attended by each of the plurality of entities at the future time period. Thus, reschedulings and/or impromptu cancellations caused by the unavailability of one or more entities or unavailability of a precise confluence location having a sufficient capacity may be prevented or at least reduced, so consumption of network bandwidth and computational resources may be reduced for the reasons previously given.

Allocating resources for the confluence may include allocating equipment for the confluence at the future time period based on the plurality of expected location indicators.

Allocating equipment for the confluence at the future time period may decrease the likelihood that appropriate equipment is unavailable for the confluence at the future time period. Thus, reschedulings and impromptu cancellations caused by the unavailability of appropriate equipment may be prevented or at least reduced, so consumption of network bandwidth and computational resources may be reduced for the reasons previously given.

Allocating the equipment for the confluence may include: determining, based on the plurality of expected location indicators, that one or more of the plurality of entities are expected to be proximate to at least one of the one or more confluence locations at the future time period; and allocating equipment for use by at least one of the one or more of the plurality of entities at the at least one of the one or more confluence locations at the future time period.

Allocating equipment for the confluence at the future time period may decrease the likelihood that equipment is unavailable at the at least one of the one or more confluence locations where it is required. Thus, reschedulings and impromptu cancellations caused by the unavailability of equipment at a given confluence location, e.g. by appropriate equipment being at an incorrect confluence location, may be prevented or at least reduced, so consumption of network bandwidth and computational resources may be reduced for the reasons previously given.

Allocating the equipment for the confluence may include determining, based on the plurality of expected location indicators, that one or more of the plurality of entities are not expected to be proximate to any of the one or more confluence locations at the future time period; and allocating equipment facilitating telecommunication with the one or more confluence locations to at least one of the one or more of the plurality of entities at the future time period.

Allocating equipment facilitating telecommunication with the one or more confluence locations to the at least one entity that is not expected to be proximate to any of the one or more confluence locations at the future time period may decrease the likelihood that the at least one entity is unable to participate in the confluence due to a lack of telecommunication facilities. Thus, reschedulings and impromptu cancellations caused by the at least one entity being unable to participate may be prevented or at least reduced, so consumption of network bandwidth and computational resources may be reduced for the reasons previously given.

Allocating resources for the confluence may include: determining, based on the plurality of expected location indicators, that one or more of the plurality of entities are not expected to be proximate to any of the one or more confluence locations at the future time period; and, in response to determining that the first one or more of the plurality of entities is not expected to be proximate to any of the one or more confluence locations, providing, to the first one or more of the plurality of entities, telecommunication information facilitating telecommunication with the one or more confluence locations.

Providing, to entities who are not expected to be proximate to any of the confluence locations, telecommunication information facilitating telecommunication with the one or more confluence locations may reduce the amount of user input and electronic communications used to configure such telecommunication. As processing user input and electronic communications consume computational resources and network bandwidth, such improvements may decrease network bandwidth and computational resource consumption. Facilitating the telecommunication may also reduce the likelihood of the telecommunication being misconfigured. Misconfiguration of the telecommunication may result in an initial attempt at telecommunication being unsuccessful or incomplete wasting computational resources and network bandwidth.

Misconfiguration may also result in one or more unauthorized entities being able to intrude upon the telecommunication. Thus, the facilitation of the telecommunication may both reduce computational resource and network bandwidth usage of the telecommunication, and improve the security of the telecommunication. In addition, misconfiguration of the telecommunication may cause the telecommunication to be inoperable or to malfunction which could result in the impromptu cancellation of the confluence. Thus, the facilitation may reduce the likelihood of impromptu cancellations of the confluence which may save computational resources and network bandwidth for the reasons previously given.

The method may further include: obtaining an updated plurality of expected location indicators; and updating the resource allocation for the confluence during the future time interval based on the updated plurality of expected location indicators.

Updating the resource allocation for the confluence based on the updated plurality of expected location indicators may reduce the likelihood of a rescheduling or impromptu cancellation of a confluence due to resources not being available which are appropriate for the updated expected locations of the entities. Preventing or reducing reschedulings and impromptu cancellations may save computational resources and network bandwidth for the reasons previously given.

The precise confluence location may have been allocated for the confluence within a general confluence location of the one or more confluence locations. Updating the resource allocation for the confluence may include determining, based on the updated plurality of expected location indicators, a change in the number of the plurality of entities expected to be proximate to the confluence location; and allocating a different precise confluence location within the general confluence location for the confluence based on the change in the number of the plurality of entities expected to be proximate to the confluence location.

Allocating a different precise confluence location based on the change in the number of the plurality of entities expected to be proximate to the confluence location may reduce the likelihood of a now unsuitable precise confluence location remaining allocated for the confluence, e.g. a precise confluence location not having sufficient capacity or being unusably large, and instead increase the likelihood that a suitable updated precise confluence location is allocated. This may prevent or reduce rescheduling and impromptu cancellations caused by the precise confluence location allocated at the time of the confluence being unsuitable. Preventing or reducing reschedulings and impromptu cancellations may save computational resources and network bandwidth for the reasons previously given.

According to a second aspect, there is provided a computing system including one or more computing devices. The one or more computing devices include one or more processors. The one or more processors are configured to: receive a request to schedule a confluence involving a plurality of entities during a future time interval; obtain a plurality of expected location indicators; and allocate resources for the confluence during the future time interval based on the plurality of expected location indicators. The confluence may be associated with one or more confluence locations. The plurality of expected location indicators may indicate the expected location of the plurality of entities during the future time interval.

According to a third aspect, there is provided, a non-transitory computer-readable medium including instructions that, when executed by a processor, cause the processor to: receive a request to schedule a confluence involving a plurality of entities during a future time interval; obtain a plurality of expected location indicators; and allocate resources for the confluence during the future time interval based on the plurality of expected location indicators. The confluence may be associated with one or more confluence locations. The plurality of expected location indicators may indicate the expected location of the plurality of entities during the future time interval.

### BRIEF DESCRIPTION OF THE DRAWINGS

Arrangements of the present invention will be understood and appreciated more fully from the following detailed description, made by way of example only and taken in conjunction with drawings in which:

FIG. 1 shows a schematic detailing a computer system for scheduling confluences in accordance with an embodiment;

FIG. 2 shows a method for allocating resources for a confluence according to an embodiment;

FIG. 3 shows a method for scheduling confluences according to an embodiment;

FIG. 4 shows a method for identifying a preferred time period of one or more time period options according to an embodiment; and

FIG. 5 shows a computing device using which the embodiments described herein may be implemented.

### DETAILED DESCRIPTION

The embodiments described herein aim to improve allocation of resources for confluences (e.g. meetings, telephone calls, video calls, etc.) of entities by utilizing data relating to one or more of the confluence entities. Improvements in the allocation of resources for confluences may include improving the scheduling of confluences, improving the allocation of locations for the confluence, and/or improving the allocation of equipment for the confluence. Improved scheduling of confluences may result in decreased user input when scheduling confluences, fewer reschedulings of confluences, and fewer impromptu cancellations of confluences caused by the unintentional absence of one or more entities required at the confluence. Improved allocation of locations and/or equipment may result in decreased user input in allocating locations and/or equipment, fewer reschedulings of confluences, and fewer impromptu cancellations of confluences as there may be a decreased likelihood of locations and/or equipment being unavailable for confluences and/or unsuitable locations and/or equipment being incorrectly allocated. In a computer-implemented confluence-resource-allocation system, processing user input, and communicating reschedulings and impromptu cancellations of confluences consume network bandwidth and computational resources. Thus, reducing these may reduce the network bandwidth and computational resources consumed by a computer-implemented confluence-resource-allocation system.

Some embodiments described herein particularly aim to improve the allocation of resources for confluences involving one or more entities that are not expected to be proximate to a confluence location, e.g. meetings involving one more attendees who are not expected to be close to a meeting room. These improvements may facilitate telecommunication between the one or more entities and confluence location(s). Facilitating such telecommunication may reduce the amount of user input and electronic communications used to configure such telecommunication. As processing user input and electronic communications consume computational resources and network bandwidth, such improvements may decrease network bandwidth and computational resource consumption.

Facilitating the telecommunication may also reduce the likelihood of the telecommunication being misconfigured. Misconfiguration of the telecommunication may result in an initial attempt at telecommunication being unsuccessful or incomplete wasting computational resources and network bandwidth. Misconfiguration may also result in one or more unauthorized entities being able to intrude upon the telecommunication. Thus, the facilitation of the telecommunication may both reduce computational resource and network bandwidth usage of the telecommunication, and improve the security of the telecommunication.

Resource Allocation System

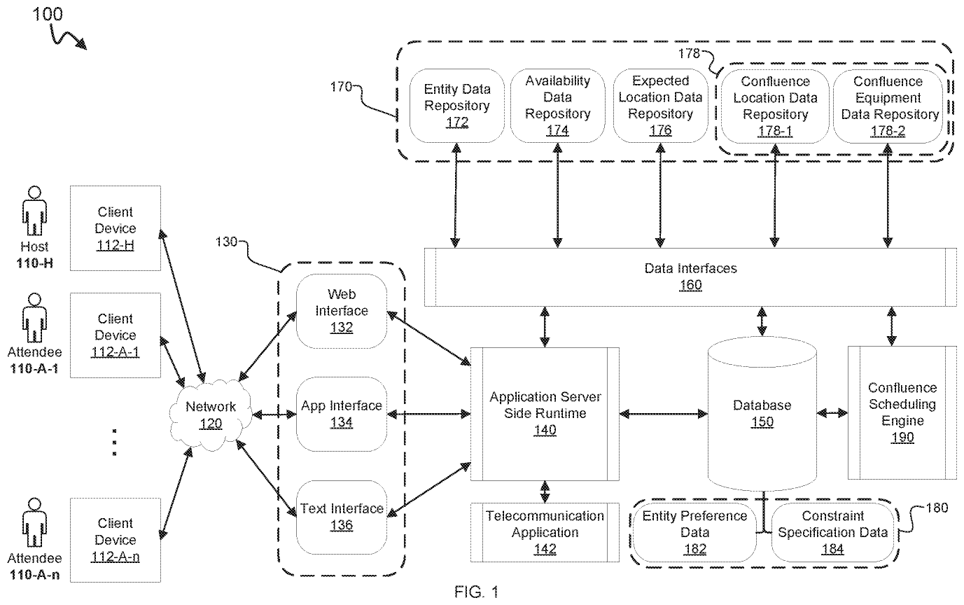

FIG. 1 shows a schematic detailing a computer system 100 for allocating resources for confluences in accordance with an embodiment. The computer system 100 is configured to allocate resources for confluences based on confluence-related data and/or entity-related data. The computer system 100 may be further configured to facilitate telecommunication between one or more of a plurality of entities 110 involved in a confluence and a confluence location.

The computer system 100 is utilized by the plurality of entities 110. Each of the plurality of entities 110 may be any of a person; a group of people; representative(s) of a group of people, e.g. representative(s) of a corporate entity; or an automated agent. The plurality of entities includes a host entity 110-H who requests scheduling of a confluence, and one or more attendee entities 110-A whose involvement in the confluence is required or at least desired.

The computer system 100 includes client devices 112 used by respective entities 110. The client devices 112 may be any suitable computing devices, e.g. smartphones, tablet computers, laptop computers, desktop computers, feature phones, and/or any other computing device configured to communicate with network 120. Where an entity is an automated agent, the respective client device 112 may be a server computing device executing the automated agent.

The client device 112-H of the host entity 110-H is utilizable by the host entity 110-H to request the scheduling of a confluence by issuing a confluence-scheduling request. The confluence-scheduling request may include one or more confluence requirements, such as one or more attendee entities 110-A required or desired at the confluence, one or more locations associated with the confluence, and the future time interval for the confluence. The host entity 110-H may request the scheduling of the confluence through one or more application(s) on the client device 112-H, e.g. a messaging application through which a confluence-scheduling request message including the one or more confluence requirements may be sent, a web browser application showing a web page for requesting the scheduling of a confluence, and/or a native application (e.g. an app) for requesting the scheduling of the confluence. User interfaces of the one or more application(s) for inputting these preferences may be displayed on a display integrated into or connected to the client device 112-H.

The client device(s) 112-A of the attendee entities 110-A may include one or more applications usable by the respective attendee entity to select one or more of a plurality of time period options. These one or more applications may include a messaging or email application displaying a message or email including the plurality of time period options and providing functionality to reply to the message with a message indicating a selected one or more of the plurality of time period options. These one or more applications may include a web browser application showing web content that includes the plurality of time period options and web user interface elements for selecting one or more of the plurality of time period options. These one or more applications may include a native application (e.g. an app) showing the multiple time period options and user interface elements for selecting one or more of the plurality of time period options.

At least some of the client device(s) 112-A of the attendee entities 110-A may include one or more applications usable by the respective attendee entity to display telecommunication information for communicating with a confluence location. These one or more applications may include a messaging or email application showing a message or email including the telecommunication information, a web browser application showing web content including the telecommunication information, and/or a native application (e.g. an app) showing the telecommunication information. These one or more applications may also include a telecommunication application, such as a video conferencing application, capable of both displaying the telecommunication information and initiating the telecommunication.

The computer system 100 also includes a network 120. The client devices 112 are connected to the network 120. The network 120 may be any suitable network over which data may be communicated. For example, the network 120 may be any interface over which data may be transferred from the one or more applications to one or more interfaces 130. For example, the network 120 may be any of or any combination of a local area network (LAN), a wireless local area network (WLAN), a wide area network (WAN), a cellular network (e.g. a GSM, 3G, 4G, 5G or CDMA network), an Intranet or the Internet.

The computer system 100 also includes the one or more interfaces 130. The one or more interfaces 130 are configured to act as gateways between messages and/or requests received from the client devices 112, over the network 120, and an application server side runtime 140. The one or more interfaces 130 may be one or more computer programs implemented on a single computing device or over a plurality of computing devices. For example, each of the one or more interfaces may be implemented as individual computer programs and each of the individual computer programs may be hosted on a different computing device, or the one or more interfaces may be implemented as a single computer program hosted on a single computing device. The one or more interfaces may also be separate to, but in communication with, the application server side runtime 140 or may be components of the application server side runtime 140.

The one or more interfaces may include a web interface 132. The web interface may provide functionality of the application server side runtime 140 to the client devices via one or more web pages and/or as a web application. The web interface 132 may receive one or more web protocol requests (e.g. HTTP requests) from a browser application on the client device 112-H of the host entity 110-H indicating a request to schedule a confluence. In response to these web protocol requests, the web interface may input this confluence-scheduling request or a transformation thereof to the application server side runtime 140. In response to the confluence-scheduling request or the transformation thereof, the application server side runtime 140 may send one or more messages indicative of suggested time periods to the web interface 132. Then, the web interface 132 may send web content (e.g. HTML content) and/or web data (e.g. REST data) including these suggested time periods to the client device 112-H of the host entity 110-H. The web interface 132 may receive one or more web protocol messages (e.g. HTTP messages) from the client device 112-H of the host entity 110-H indicating a selection of one or more of the suggested time periods as time period options, and the web interface 132 may input this selection to the application server side runtime 140. Further confluence-scheduling functionality of the application server side runtime 140 may be provided to the client device 112-H of the host entity 110-H via the web interface 132 using similar mechanisms.

The web interface 132 may send web content (e.g. HTML content) and/or web data (e.g. REST data) including time period options to the client devices 112-A of the attendee entities 110-A, where these time period options have been received by the web interface from the application server side runtime 140, e.g. in response to a selection of one or more time period suggestions being submitted to the application server side runtime 140. The web interface 132 may receive one or more web protocol messages (e.g. HTTP messages) from the client devices 112-A of the attendee entities 112-A indicating selections of one or more of the time period options. The web interface 132 may process these web protocol messages and input the selections of the one or more of the time period options to the application server side runtime.

The web interface 132 may send web content (e.g. HTML content) and/or web data (e.g. REST data) including telecommunication information for facilitating telecommunication with one or more confluence locations to the client device 112-A of at least one of the one or more attendee entities 110-A. The web content may be sent to the client device 112-A based on one or more messages received by the web interface from the application server side runtime 140, where the one or more messages include the telecommunication information and indicate which of the at least one of the one or more attendee entities 110-A to send the telecommunication information to. The at least one of the one or more attendee entities 110-A may be at least one attendee entity that is not expected to be proximate to a confluence location at a time of a confluence.

The one or more interfaces 130 may include an app interface 134. The app interface 134 may provide functionality of the application server side runtime 140 to the client devices 112 via one or more services utilisable by native application(s) on the client devices 112. The app interface 134 may receive one or more service requests (e.g. application programming interface (API) requests, representational state transfer (REST) API requests, or Simple Object Access Protocol (SOAP) requests) from a native application on the client device 112-H of the host entity 110-H indicating a request to schedule a confluence. In response to these service requests, the app interface 134 may input this confluence-scheduling request or a transformation thereof to the application server side runtime 140. In response to the confluence-scheduling request or the transformation thereof, the application server side runtime 140 may send one or more messages indicative of suggested time periods to the app interface 134. Then, the app interface 134 may send one or more service requests indicating these suggested time periods to the client device 112-H of the host entity 110-H for use by the native application. The app interface 134 may receive one or more service requests from the native application of the client device 112-H of the host entity 110-H indicating a selection of one or more of the suggested time periods as time period options, and the app interface 134 may input this selection to the application server side runtime. Further confluence-scheduling functionality of the application server side runtime 140 may be provided to the client device 112-H of the host entity 110-H via the app interface 134 using similar mechanisms.

The app interface 134 may send service requests including time period options to the client devices 112-A of the attendee entities 110-A for use by native application(s) on the client device, where these time period options have been received by the app interface 134 from the application server side runtime 140, e.g. in response to a selection of one or more time period suggestions being submitted to the application server side runtime 140. The app interface 134 may receive one or more service requests from the client devices 112-A of the attendee entities 110-A indicating selections of one or more of the time period options made in a native application on the client device. The app interface 134 may process these service requests and input the selections of the one or more of the time period options to the application server side runtime 140.

The app interface 134 may send service requests including telecommunication information for facilitating telecommunication with one or more confluence locations to the client device 112-A of at least one of the one or more attendee entities 110-A for use by native application(s) on the client device. The native application(s) user the telecommunication information be or include a confluence scheduling application, a calendar application, and/or a telecommunication application, such as a video conferencing application. Service request may be sent to the client device 112-A based on one or more messages received by the app interface 134 from the application server side runtime 140, where the one or more messages include the telecommunication information and indicate which of the at least one of the one or more attendee entities 110-A to send the telecommunication information to. The at least one of the one or more attendee entities 110-A may be at least one attendee entity that is not expected to be proximate to a confluence location at a time of a confluence.

The one or more interfaces 130 may include a text interface 136. The text interface 136 may provide functionality of the application server side runtime 140 to the client devices 112 via messages communicated between the text interface 136 and the client devices 112. The text interface 136 may receive one or more messages (e.g. short message service (SMS) messages, rich communication service (RCS) messages, messaging app messages, social network messages) from the client device 112-H of the host entity 110-H, where the one or more messages include a request to schedule a confluence. In response to these one or more messages, the text interface 136 may input a confluence-scheduling request based on the request in the one or more messages to the application server side runtime 140. In response to the confluence-scheduling request, the application server side runtime may send one or more messages indicative of suggested time periods to the text interface 136. Then, the text interface 136 may send one or more messages including the suggested time periods to the client device 112-H of the host entity 110-H. The text interface 137 may receive one or more messages from the client device 112-H of the host entity 110-H indicating a selection of one or more of the suggested time periods as time period options, and the text interface 136 may input this selection to the application server side runtime 140. Further confluence-scheduling functionality of the application server side runtime 140 may be provided to the client device 112-H of the host entity 110-H via the text interface 136 using similar mechanisms.

The text interface 136 may send messages including time period options to the client devices 112-A of the attendee entities 110-A, where these time period options have been received by the text interface 136 from the application server side runtime 140, e.g. in response to a selection of one or more time period suggestions being submitted to the application server side runtime 140. The text interface 136 may receive one or more messages from the client devices 112-A of the attendee entities 110-A indicating selections of one or more of the time period options. The text interface 136 may process these messages and input the selections of the one or more of the time period options to the application server side runtime 140.

The text interface 136 may send one or more messages including telecommunication information for facilitating telecommunication with one or more confluence locations to the client device 112-A of at least one of the one or more attendee entities 110-A. The one or more messages may be sent to the client device 112-A based on one or more messages received by the text interface 136 from the application server side runtime 140, where the one or more messages include the telecommunication information and indicate which of the at least one of the one or more attendee entities 110-A to send the telecommunication information to. The at least one of the one or more attendee entities 110-A may be at least one attendee entity that is not expected to be proximate to a confluence location at a time of a confluence.

The computer system 100 includes the application server side runtime 140. The application server side runtime 140 may be a computer program, or multiple computer programs, implemented on a single computing device or over a plurality of computing devices. The application server side runtime 140 provides confluence scheduling functionality. For example, the application server side runtime 140 may access a confluence schedule, e.g. stored in a database 150 and/or accessible through data interfaces 160, and provide the confluence schedule or a part thereof to one or more interfaces in response to requests from one of the interfaces 130, e.g. in response to a request (e.g. an API call and/or service request) from one of the interfaces 130. As another example, the application server side runtime 140 may receive a request from one of the interfaces 130 to schedule a confluence. In response to the request, the application server side runtime 140 may communicate with the database 150, the data interfaces 160 and/or a confluence scheduling engine 190 (either directly or indirectly via the database) to determine one or more time one or more time period suggestions, and provide these suggestions to the interface 130.

The computer system 100 may also include or operate in conjunction with a telecommunication application 142. The telecommunication application 142 may be a computer program, or multiple computer programs, implemented on a single computing device or over a plurality of computing devices. The telecommunication application 142 may be an application for arranging and providing telecommunication services to the client devices 112, e.g. a video conferencing server application. The telecommunication application 142 may interact with the application sever side runtime 140 to provide telecommunication information for facilitating telecommunication between one or more attendee entities 110-A and one or more confluence locations to the application server side runtime 140. Such information may be provided in response to a request from the application server side runtime 140 indicating the one or more confluence locations and the one or more confluence attendee entities 110-A to which telecommunication information needs to be provided.

The computer system 100 includes the database 150. The data stored in the database 150 includes confluence scheduling information, e.g. a confluence schedule. The database 150 provides data storage and access functionality, e.g. functionality whereby data can be written to and read from the database 150. The database 150 may also facilitate the deletion of data from the database. The database 150 may be any combination of software and hardware capable of providing this functionality. For example, the database software may be: a relational database server, e.g. a Standard Query Language (SQL) database server; a NoSQL database server, e.g. a key-value store server, a column store server, a document store server or a graph database server; or a file storage server, e.g. a file transfer protocol. The hardware on which the database software is implemented may be one or more suitable computing devices, e.g. one or more server computing devices and/or one or more computing devices of a cloud computing system.

The database 150 is configured to interact with the application server side runtime such that the application server side runtime 140 may read data from and write data to the database 150. The database 150 may communicate with, e.g. receive data to be written from and provide data to be read to, the application server side runtime 140 over a network of any of the types previously mentioned. The database 150 may communicate using a database specific communication technology, e.g. a database specific protocol, or a widely applicable communication technology, e.g. SOAP or REST service calls. Alternatively or additionally, the database 150 may communicate with the application server side runtime 140 using API calls, interprocess communication and/or shared storage. The aforementioned communication technologies may be particularly applicable when the database 150 and the application server side runtime 140 are hosted on the same computing device.

The computer system 100 also includes one or more data interfaces 160. The one or more data interfaces 160 are configured to load data from one or more data repositories 170 into the database 150. The one or more data interfaces 160 may also synchronise changes to the corresponding data loaded into the database 150, e.g. updates to the database by the application server side runtime 140, back to the data repositories. The one or more data interfaces 160 may be one or more computer programs implemented on a single computing device or over a plurality of computing devices. For example, each of the one or more interfaces may be implemented as individual computer programs and each of the individual computer programs may be hosted on a different computing device, or the one or more interfaces may be implemented as a single computer program hosted on a single computing device.

Each of the plurality of data repositories 170 may be part of the computer system 100 or external to the computer system 100. Each of the data repositories 170 may be implemented using any hardware and/or software combination using which the relevant data can be loaded and provided to the one or more data interfaces. For example, each of the data repositories 170 may be or include a database: flat file storage: application specific data stores; and/or applications for dynamic data generation and/or transformation. Furthermore, in an alternative embodiment, the data repositories 170 are integrated within the database 150 itself. In this case, there may be no need for the data interface 160.

The one or more data repositories 170 may include an entity data repository 172. The entity data repository includes entity descriptors for each of a set of entities. The set of entities may include all, a subset, or at least one of the plurality of entities. Each of the entity descriptors may include information about the respective entity. Examples of such information include: entity role; entity seniority; entity type, e.g. whether the entity is an individual, a group, a representative of a group, or an automated agent; entity organisation, e.g. which company the entity is a member of; entity groups, e.g. which departments, teams and/or committees the entity is a member of; and/or entity contact details, e.g. an email address, a phone number, a social media username, and/or a messaging application username.

The one or more data repositories 170 may include an availability data repository 174.

The availability data repository 174 may include entity-specific availability data indicating when certain entities are expected to be available or unavailable for confluences. The entity-specific availability data may be sourced from calendars of the set of entities, e.g. from calendar data of a calendar application. The entity-specific availability data may alternatively or additionally be sourced from a human resources (HR) system designating absence data indicating that one or more entities are not expected in be available at a given time (e.g. because of annual leave absence, sickness absence, non-working days (e.g. for part-time workers) and/or public holidays). The entity-specific availability data may alternatively or additionally be sourced by processing emails of the certain entities, with their consent, to determine time periods when they are not expected in be available which have not been included in their calendars. The entity-specific availability data may include data for future time intervals such that future confluences may be scheduled for when entities are available based on their stated or inferred future availability. The entity-specific availability data may also include historic data indicating when given entities were available or not available in the past. Such historic data may be used to infer when entities are likely to be available or not during future time intervals. For example, an entity may have been unavailable at a given time period on a given day on most weeks for the past year but may not have included this in their calendar for the coming week. However, it is reasonably likely that this may be an oversight by the entity, and the entity will, in fact, also be unavailable this week, so scheduling confluences including the entity at the given time period on the given day should still be avoided.

The availability data repository 174 may include generic availability data indicating when all, most or a group of entities are unavailable. For example, the generic availability data may include data indicating that all entities except for a skeleton group of entities will not be available on a given day, e.g. because of a public holiday, an emergency, an information systems outage or government-mandated closure. As another example, the generic availability data may include data indicating that a group of entities are unavailable over a designated lunch break period for that group of entities. The generic availability data may also include data indicating that entities will be available within certain working hours except for conflicts and variations. Generic availability data may be sourced from a facilities management system, a human resources system and/or a calendar system.

The one or more repositories may include an expected location data repository 176.

The expected location data repository 176 may include entity-specific expected location data. The entity-specific location data may be sourced from calendars of the set of entities, e.g. from calendar data of a calendar application, which may indicate when the entity is planning to be proximate to the confluence location, e.g. in the office, and when the entity is not planning to be proximate to the confluence location, e.g. working from home. The entity-specific expected location data may alternatively or additional be sourced from a human resources (HR) system designating days of the week where it has been agreed that the entity will be proximate to the confluence location. The entity-specific expected location data may alternatively or additionally be sourced by processing email of certain entities, with the entities' consent, to determine times that the entity has indicated that they will or will not be proximate to the confluence location but have not been included in their calendar. The entity-specific expected location data may include data for future time intervals such that it can be determined whether an entity is expected to attend confluences remotely or in-person.

The entity-specific expected location data may also include historic data indicating when given entities were proximate to the confluence location. Such historic data may be used to infer when entities are likely to be proximate to the confluence location during future time intervals. For example, an entity may have been proximate to the confluence location on a given day of the week for most weeks of the year but may have not indicated this in their calendar for the coming week. However, it is reasonably likely that this may be an oversight by the entity, and the entity will, in fact be proximate to the confluence location on the given day of the week. In addition to one or more of the data sources previously indicated, the historic data may include location tracker data indicating the past location of entities which has been collected with the entities' consent. The entities may also limit when such location tracker data may be collected and the granularity of this location tracker data, e.g. an entity may indicate that location tracker data can only be collected on working days and only to the nearest kilometre. The location tracker data may be collected using devices including a global positioning system (GPS) receiver component carried by entities, such as the entities' smartphones. The location tracker data may be used to determine whether, at given times and days of the week in the past, the entity was proximate to a confluence location and be used to infer when they are likely to be proximate to this confluence location in the future.

The expected location data repository 176 may include generic expected location data, indicating when all, most or a group of entities are expected to be proximate or not proximate to a confluence location. For example, the generic availability data may include data indicating that all entities except for a skeleton group of entities are not expected to be proximate to a confluence location on a given day, e.g. because of a public holiday, an emergency, refurbishment of an office or part thereof, or a government-mandated office closure. Such generic expected location data may, in certain instances, override entity-specific expected location data. For example, if an office is closed then an entity cannot be in the office even if the entity-specific expected location data indicates otherwise. Generic expected location data may be sourced from a facilities management system, a human resources system and/or a calendar system.

The one or more data repositories 170 may include one or more confluence resource data repositories 178. The one or more confluence data repositories 178 may include data detailing resources that can be allocated for confluences, such as confluence locations, e.g. meeting rooms, and confluence equipment, e.g. video conferencing equipment. The one or more confluence resource data repositories 178 may include a confluence location data repository 178-1 and a confluence equipment data repository 178-2. While these are described as two distinct repositories for ease of explanation, a single confluence resource data repository 178 containing both confluence location data and confluence equipment data could be used.

The confluence location data repository 178-1 includes details of each of a set of confluence locations.

The confluence locations may include general confluence locations. Examples of general confluence locations include an: offices or floors or areas thereof; cities or parts thereof; and geographic regions, e.g. counties or boroughs. The details of each general confluence location may include: geographical location, e.g. an address of the general confluence location, or part thereof, and/or a latitude and longitude of the general confluence location; a name of the general confluence location, e.g. the name of the office, city or geographic region; and a capacity of the general confluence location, e.g. a maximum number of entities that can be accommodated within the general confluence location.

The confluence locations may include precise confluence locations suitable for hosting a confluence, such as a meeting room, a meeting pod, a meeting hall, a multiuse workspace, a videoconferencing room, or a café suitable for hosting meetings. The precise confluence locations may be included in one or more general confluence locations. The details of each precise confluence location may include, for example: geographic location, e.g. the address of the confluence location; building location, e.g. which floor and/or section of a building, such as an office, the confluence location is on; name, e.g. the name of a meeting room; capacity, e.g. a maximum number of entities that can be accommodated in the confluence location; size, e.g. the dimensions and/or area of the confluence location; lighting, e.g. an indication of an amount of natural light available at the confluence location; décor, e.g. an indication as to whether the confluence location is sufficiently well decorated to host confluences involving external entities; and/or fixed equipment at the confluence location, e.g. whether the confluence location has a projector, videoconferencing equipment, tables, seating, and/or a whiteboard.

The confluence equipment data repository 178-2 includes details of equipment that may be utilized for a confluence. Examples of confluence equipment may include: videoconferencing and/or teleconferencing equipment; computing devices having videoconferencing and/or teleconferencing functionality; chairs; tables; projectors and/or associated screens; televisions and/or monitors; whiteboards; and/or flipcharts. The confluence equipment may include either or both of equipment to be used for the confluence at the confluence location and/or equipment to be used by entities attending the confluence remotely. The equipment to be used at the confluence location may usually be located proximate to but not at the confluence location but be allocated to be moved to the confluence location at the time of the confluence. For example, the equipment may include chairs and tables stored in a cupboard in the office in which the confluence location is located, and these chairs and tables may be moved to the confluence location for the confluence. The equipment to be used by entities attending remotely may be equipment usable by these entities to access the confluence remotely, e.g. a secure computing device with video conferencing functionality. Examples of details of the equipment that may be included in the data are: a location of the equipment, e.g. its proximity to one or more confluence locations; a make and/or model of the equipment, e.g. a make and/or model of a computing device; a specification of the equipment, e.g. the resolution of video conferencing equipment; an aesthetic of the equipment, e.g. whether given chairs are considered to have the correct aesthetic for hosting confluences with external clients; a capacity of the equipment, e.g. the number of entities that can be accommodated at a table; and/or a transportability of the equipment, e.g. how feasible it is to move the equipment between different parts of an office based on its size and weight.

The computer system 100 includes confluence scheduling configuration data 180. The confluence scheduling configuration data 180 may be stored in the database 150 and/or may be stored as settings associated with a confluence scheduling engine 190, e.g. associated registry settings or a configuration file. The confluence scheduling configuration data 180 is used by the confluence scheduling engine 190 in scheduling confluences and/or allocating resources for scheduled confluences.

The confluence scheduling configuration data 180 may include entity preference data 182. The preference data may indicate preferences of one or more entities as to when confluences should be scheduled and what resources, e.g. confluence equipment and/or locations, should be allocated to it. For example, an entity may have a preference to attend confluences in person so would rather the confluence be scheduled for a time when they are proximate to an appropriate confluence location, while another entity may prefer to attend confluences remotely. As another example, an entity may have a preference to have the confluence in a confluence location with adequate natural light. As an example in relation to resource allocation, some entities may be particularly sensitive to lower video quality so have a strong preference for high resolution videoconferencing equipment to be used for confluences that they are hosting or attending.

The confluence scheduling configuration data 180 may include constraint specification data 184. The constraint specification data 184 may indicate rules and/or other criteria that a confluence schedule must satisfy. For example, the constraint specification data 184 may include maximum occupancy or density of occupancy for a given group of confluence locations, e.g. confluence locations in a given office or on a given floor of an office at or over given time periods. This may be defined by technical or regulatory requirements, such as health and safety rules. For instance, social distancing rules may limit the number of confluences at confluence locations on a given floor of an office that can be scheduled to start and/or end at similar times, as having a large number of confluences beginning and/or ending at similar times could result in overcrowding of lifts or stairs. Equally, fire safety rules may limit the number of confluences being scheduled in confluence locations near a given fire exit, such that no particular fire exit is likely to be overwhelmed.

The computer system 100 includes the confluence scheduling engine 190. The confluence scheduling engine 190 may be a computer program, or multiple computer programs, implemented on a single computing device or over a plurality of computing devices. The confluence scheduling engine 190 schedules confluences and allocates resources for confluences based on data from the database 150, the one or more data repositories 170, the confluence scheduling configuration data 180, and/or data received from the client devices 112. The resource allocation engine 190 may store details of scheduled confluences and resource allocations for these confluences to the database 150.

The scheduling of the confluences and allocation of resources for the confluence may also be based on communications, e.g. data transfers and service requests, between the confluence scheduling engine 190 and another one or more computer systems (not shown) for scheduling confluences, e.g. a computer system for scheduling confluences other than the computer system 100. The another one or more computer systems may be computer systems similar to the computer system 100, e.g. different instances and/or implementations of computer systems having similar functionality and/or components. The communication may be with a confluence scheduling engine and/or application server side runtime of these another one or more computer systems. These another one or more computer systems may include one or more computer systems of one or more other organisations than the one operating the computer system 100. The another one or more computer systems may include one or more computer systems of one or more different parts of the same organisation, e.g. different offices, different departments and/or different legal entities of an organisation may have distinct computer systems. The confluence scheduling engine 190 may be prevented from directly accessing, or otherwise not be able to access, the data of the another one or more computer systems, e.g. for reasons of confidentiality, privacy and security. This data may be of any of the types discussed in relation to the computer system 100. For example, the another one or more computer systems may each include calendar data for a respective organisation that cannot be accessed by the confluence scheduling engine 190. The communications between the confluence scheduling engine 190 and the another one or more computer systems may facilitate confluence scheduling and resource allocation for confluences based on the data stored in the another one or more computer systems without exposing this data to the confluence scheduling engine 190.

Where the another one or more computer systems are systems configured similarly to the computer system 100, this may be through the confluence scheduling engine 190 sending one or more suggested future times to the another one or more computer systems and the another one or more computer systems selecting one or more of these one or more suggested future times based on information stored in their respective data repositories. The selected one or more suggested future times may then be sent back to the computer system 100 to process further (e.g. identify a preferred time period) and/or to report back to the client device of the host entity. For example, the communications could indicate to the confluence scheduling engine 190 that certain future time periods are unsuitable for a confluence because at least one external attendee entity is not expected to be available. It may have been determined, by a computer system of the external attendee entity's organisation, that the at least one external attendee entity is not expected to be available based on calendar data stored in and/or accessible by the computer system of the external entity's organisation. However, this calendar data is not exposed to the confluence scheduling engine 190 of the computer system 100.

Confluence Resource Allocation Method

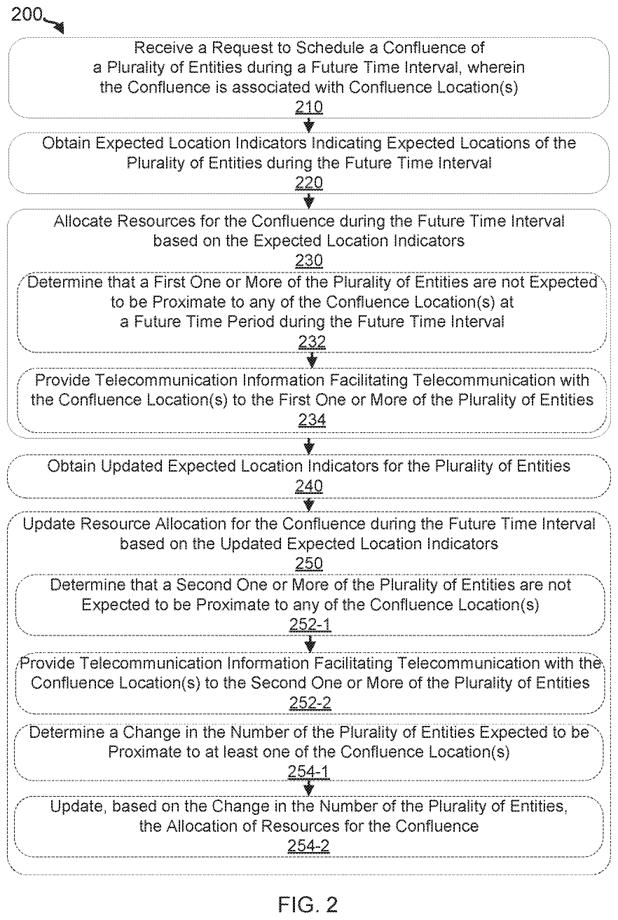

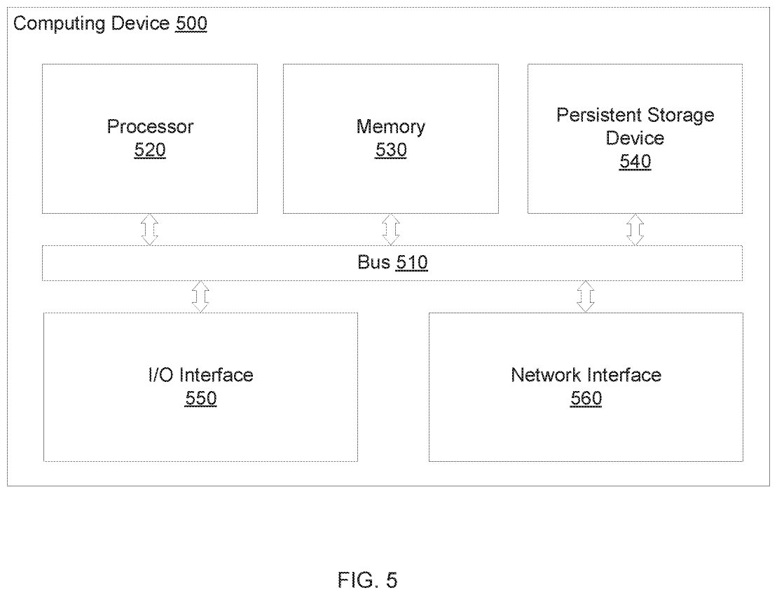

FIG. 2 shows a method 200 for allocating resources for a confluence according to an embodiment. The method 200 may be implemented as one or more computer-executable instructions executed on one or more computing devices, e.g. the computing device 500 described in relation to FIG. 5. The method 200 may be performed by the application server side runtime 140 and/or the confluence scheduling engine 190 described with respect to FIG. 1. Optional steps are indicated via dashed lines.

At step 210, a request to schedule a confluence of a plurality of entities during a future time interval is received. The request may be received from a client device of a host entity desiring to schedule the confluence. The confluence of the plurality of entities may be an assemblage, a gathering, an assembly, a meeting and/or a convergence of the plurality of entities. Each of the plurality of the entities may be any of a person; a group of people; representative(s) of a group of people, e.g. representative(s) of a corporate entity; or an automated agent. The future time interval may start at a first time and end at a second time with a length of time between the first time and the second time. Both the first and second times may be specified in the request, or one of the first and second times may be specified along with a proposed duration for the time interval. The future time interval may be unbounded, e.g. the future time interval may start at a first time but the future time interval may not have a set end or the future time interval may end at a second time but a start may not be explicitly specified. Each of the first time and/or the second time may include a date component and a time of day component. The time of day component may include hour components and minute components. The confluence is associated with one or more confluence locations, e.g. one or more general confluence locations and/or one or more precise confluence locations as described with respect to the confluence location data repository 178-1.

At step 220, expected location indicators indicating expected locations of the plurality of entities during the future time interval are obtained. Obtaining the expected location indicators may include retrieving the expected location indicators, e.g. from the expected location data repository 176, and/or receiving the expected location indicators, e.g. via a HTML message or service request. The expected location indicators may be derived from either or both of entity-specific location data and/or generic location data of any of the types described with respect to the expected location data repository 176. Where an entity is expected to be at multiple locations during the future time interval, the respective location indicator may indicate each of these locations and the parts of the future time interval where the entity is expected to be at each of these locations.

At step 230, resources are allocated for the confluence during the future time interval based on the expected location indicators.

Where at least one location of the associated one or more confluence locations is a general confluence location, allocating the resources for the confluence may include allocating one or more precise confluence locations, e.g. one or more meeting rooms, within the general confluence location, e.g. one or more respective offices. The size and/or capacity of each of the one or more precise confluence locations allocated (e.g. the number of people who can be accommodated in a meeting room) may be based on the number of entities who are expected to be proximate to the general confluence location based on the expected location indicators. This may enable utilisation of available precise confluence locations, e.g. meeting rooms, within general confluence locations, e.g. offices, to be maximised.

Allocating the resources for the confluence during the future time interval may include determining a future time period for the confluence within the future time interval, e.g. the specific time(s) at which the confluence is to occur within the future time interval. The future time period may be shorter than the future time interval. The length of the future time period may be equal to a request confluence duration. The future time interval may therefore indicate a broad availability or preference by the host, and the most appropriate future time period within this future time interval may be chosen and allocated for the confluence.

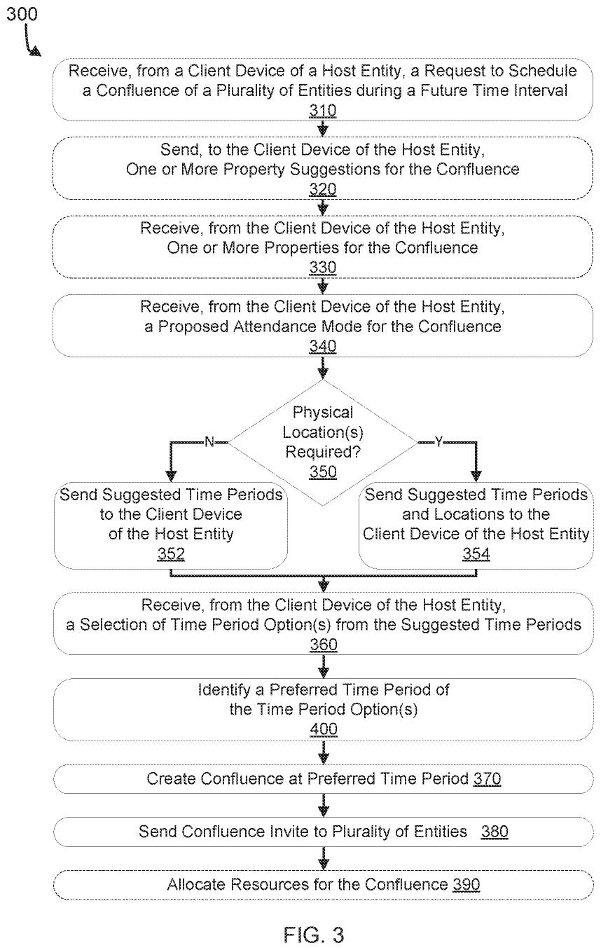

The determination of the future time period may include determining, based on the expected location indicators, a future time period within the future time interval where at least entities of the plurality of entities who are required to physically attend the confluence are proximate to the one or more confluence locations. The determination may be further based on whether others of the plurality of entities, e.g. entities who may prefer to but are not required to physically attend the confluence, are proximate to the one or more confluence location. The determination may be further based on the availability of certain confluence equipment over the future time interval. An example method 300 by which the future time interval for the confluence may be determined is described in relation to FIG. 3.

Allocating the resources for the confluence during the future time interval may include allocating equipment for the confluence, e.g. any of the equipment described with respect to the confluence equipment data repository 178-2. The equipment allocated may be based on the expected location indicators. For example, equipment may be allocated for entities depending on whether or not they are expected to be proximate to the one or more confluence locations. As described in relation to confluence equipment data repository 178-2 different equipment may be required dependent on whether an entity is proximate to the confluence location, hence attending in person, or is not, hence attending remotely. For example, an entity attending in person may require a chair, while an entity attending remotely may require video conferencing equipment.

Allocating resources for the confluence may include a step 232 of determining that a first one or more of the plurality of entities are not expected to be proximate to any of the one or more confluence location(s) at a future time period during the future time interval. The future time period may be the future time period at which the confluence is scheduled to take place.

Allocating resources for the confluence may include a step 234 of providing telecommunication information facilitating telecommunication by the first one or more of the plurality of entities with the one or more confluence locations. Where the one or more confluence locations are one or more general confluence locations, the provided telecommunication information may facilitate telecommunication with respective precise confluence locations within the one or more general confluence locations. The provided telecommunication information may include a phone number, a meeting code, name and/or number; a meeting password; and/or a meeting link, e.g. a meeting universal resource identifier (URI). The telecommunication information may facilitate telecommunication using a telecommunication application, e.g. telecommunication application 142 described with respect to FIG. 1.

At step 240, updated expected location indicators for the plurality of entities are obtained. The updated expected location indicators may take any of the same forms as the expected location indicators and may be obtained using any of the same mechanism. The updated expected location indicators may be obtained in response to a scheduled or manually triggered request to update a confluence schedule. Alternatively or additionally, the updated expected location indicators may be obtained in response to an event message received indicating that the expected locations of one or more of the entities have changed.

At step 250, the resource allocation for the confluence during the future time interval is updated based on the updated expected location indicators. The updating of the resource allocation may include changing one or more precise confluence locations allocated for the confluence, changing the equipment allocated for the confluence, and/or changing the use of telecommunication for the confluence.

Updating the resource allocation for the confluence may include a first submethod 252.

The first submethod 252 includes a step 252-1 of determining, based on the updated expected location indicators, that a second one or more of the plurality of entities are not expected to be proximate to any of the confluence locations. The second one or more of the plurality of entities may be different entities to the first one or more of the plurality of entities. The second one or more entities may be entities that were previously expected, based on the expected location indicators, to be proximate to at least one of the one or more confluence locations but are no longer expected, based on the updated expected location indicators, to be proximate to any of the one or more confluence locations.

The first submethod 252 includes a further step 252-2 of providing telecommunication information facilitation telecommunication with the one or more confluence locations to the second one or more of the plurality of entities. The telecommunication information may be of any of the types described in relation to providing the telecommunication information in step 234.

Updating the resource allocation for the confluence may alternatively or additionally include a second submethod 254.

The second submethod 254 includes a step 254-1 of determining a change in the number of plurality of entities expected to be proximate to at least one of the one or more confluence locations based on the updated expected location indicators. The change may be an increase or a decrease in the number of entities expected to be proximate to a given confluence location. The change in the number of entities may be caused by additional entities of the plurality of entities being proximate to the confluence location, one or more entities that were expected to be proximate to the confluence location no longer being expected to be proximate to the confluence location, or both, e.g. two additional entities may be expected to be proximate to the confluence location but another entity that was expected to be proximate to the confluence location is no longer expected to be proximate.

The second submethod 254-2 includes a further step of updating the allocation of resources for the confluence based on the change in the number of plurality of entities expected to be proximate to the at least one of the one or more confluence locations. Where there is an increase in the number of the plurality of entities expected to be proximate to a given confluence location of the one or more confluence locations, the updating of the allocation of resources may include allocating a precise confluence location having a greater capacity within the given confluence location. For example, allocating a larger meeting room within an office where the given confluence location is an office. Where there is a decrease in the number of the plurality of entities expected to be proximate to the given confluence location, the updating of the allocation of resources may include allocating a precise confluence location have a lesser capacity within the given confluence location. For example, allocating a smaller meeting room within an office where the given confluence location is an office. This may facilitate dynamic meeting room usage maximisation. Updating the allocation may alternatively or additionally include updating the allocation of confluence equipment dependent on the change in number of the plurality of entities, e.g. the number of chairs allocated for the confluence. Updating the allocation may also alternatively or additionally include updating the future time period during the future time interval at which the confluence is scheduled and correspondingly the future time period at which the resources are allocated. For example, if there is a decrease in the number of the plurality of entities expected to be proximate to at least one of the one or more confluence locations at a future time period at which the confluence was previously schedule, the confluence may be rescheduled to another future time period during the future time interval where more of the plurality of entities are proximate to the confluence location.

The above method may be applied in scenarios where multiple confluences are being scheduled, and resources accordingly allocated for each of these confluences. The allocation of resources for confluences may, therefore, involve determining a priority of each confluence and prioritising allocation of resources to those confluences having the greatest priority. The priority of each confluence may be specified as a confluence priority weight representative of an importance of the confluence based on a multiplicity of factors. The multiplicity of factors may include: the importance of the entities of the confluence (e.g. whether one or more of the entities are VIP entities); the general availability of the entities of the confluence, e.g. confluences involving entities having little availability may have to be given a greater priority; a host entity's assessment of the priority, e.g. an indication from the host entity as to whether they consider the confluence's priority to be high, medium or low; the type of confluence, e.g. types of confluences including VIPs or external entities, such as board meetings or interviews, may be given greater priority while regular confluences of internal entities may be given a lower priority.

Confluence Scheduling Method

FIG. 3 shows a method 300 for scheduling confluences according to an embodiment. The method may be implemented as one or more computer-executable instructions executed on one or more computing devices, e.g. the computing device 500 described in relation to FIG. 5. The method 300 may be performed by the application server side runtime 140 and/or the confluence scheduling engine 190 described with respect to FIG. 1. Optional steps are indicated via dashed lines.

At step 310, a request to schedule a confluence of a plurality of entities during a future time interval is received from a client device of a host entity. The confluence-scheduling request may include one or more confluence properties and/or requirements, such as attendee entities required or desired at the confluence; one or more confluence locations associated with the confluence, e.g. one or more general confluence locations; and the future time interval for the confluence. The plurality of entities may include internal entities, e.g. entities within the same organisation as the host entity, and external entities, e.g. entities not within the same organisation as the host entity.

At step 320, one or more property suggestions for the confluence may be sent to the client device of the host entity. The one or more properties suggested may include: one or more additional attendee entities for the confluence; one or more additional confluence locations to be associated with the confluence; and/or suggestions of potential changes to the future time interval for the confluence (e.g. for the event that the initial future time interval chosen is not appropriate). The client device of the host entity may display the one or more property suggestions.

At step 330, one or more properties for the confluence may be received from the client device of the host entity. The received one or more properties may include at least one of the one or more properties suggested, e.g. the received one or more properties may include a confirmation of at least one of the one or more property suggestions for the confluence.

At step 340, a proposed attendance mode for the confluence is received, e.g. whether the confluence is to be fully remote or is to be at least partially in person. In an in-person confluence, at least some of the plurality of entities are to be located at one or more precise confluence locations.

At step 350, it is determined whether a physical location for the confluence is required, e.g. based on the proposed attendance mode for the confluence received from the client device. If the confluence is to be at least partially in person then a physical location is required. If the confluence is remote then a physical location is not required.

If a physical location is not required then step 352 is performed, where suggested time periods for the confluence are sent to the client device of the host entity. The suggested time periods are during the future time interval. The suggested time periods may be determined based off any suitable data, e.g. data included in the entity data repository 172, the availability data repository 174 and the confluence resource data repositories 178. For example, the suggested time periods may be determined as a plurality of time periods where the plurality of entities are available for a confluence and/or where equipment required for the confluence is available. The suggested time periods may also be based on whether given entities are considered necessary or desirable to a confluence. For example, if there are no time periods within the future time interval where all of the entities are available then time periods where all of the entities considered necessary are available may be suggested. The suggestions may also be based on the preferences of entities, e.g. the entity preference data 182, the importance of entities (e.g. as defined by a numerical priority value associated with each entity), e.g. a VIP status of one or more entities, or both. For example, the suggested time periods may be those time periods where all necessary entities are available which are preferred by a VIP entity. The suggestions of time periods may also be based on a priority of the confluence. For example, where the confluence has a high priority, one or more time periods where lower priority confluences are currently scheduled may be included in the suggestions, while, if the confluence has a low priority, time periods where other confluences are already scheduled may be excluded from the suggestions.

If a physical location is required then step 354 is performed, where suggested time periods and suggested confluence locations are sent to the client device of the host entity. Suggested time periods may be determined as described in relation to step 352 but will also be dependent on availability of confluence locations as indicated by confluence location data including indications of the availability of each of a set of confluence locations. The confluence location data may be obtained from a confluence location data source, e.g. the confluence location data repository 178-1. The suggested confluence locations may be a plurality of precise confluence locations. The suggested confluence locations may be determined based on the number of the plurality of entities for the confluence, e.g. a meeting room having a large enough capacity should be allocated. The suggested confluence locations may also be determined based on the preferences of the plurality of entities, e.g. entity preference data 182. These preferences may include preferences relating to the equipment available at a confluence location; the lighting at a confluence location, e.g. the amount of natural light available; the décor of a confluence location, e.g. whether the confluence location has adequate décor for hosting VIP entities and/or external entities, and where the confluence location is located, e.g. the floor of an office that the confluence location is on. Where entity preferences are used, the preferences of VIP entities may be prioritised.

At step 360, a selection of one or more time period options from the suggested time periods is received from the client device of the host entity, e.g. the host entity selects one or more of the suggested time periods as one or more time period options to be sent to the others of the plurality of entities. If a physical location is required, suggested confluence locations may also be selected as one or more confluence location options.

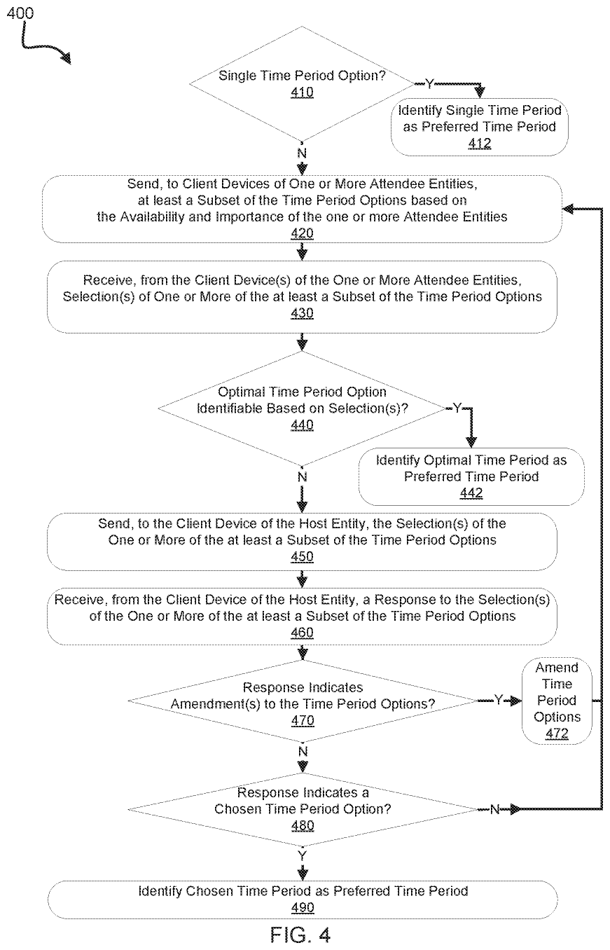

At step 400, a preferred time period of the time period options is identified. The step 400 is described in detail in relation to FIG. 4. The step 400 may also include identifying a preferred confluence location of one or more confluence locations where a physical location is required.

At step 370, a confluence is created at the preferred time period. Creating the confluence may include storing details of the confluence to a confluence schedule stored in a database, e.g. the database 150.

At step 380, invites to the confluence are sent to the plurality of entities. For example, calendar invites may be sent to the plurality of entities. The calendar invites may be sent in an open calendar invitation format and/or in an application-specific calendar invitation format. The calendar invites may include details of the confluence. The details of the confluence may include the time of the confluence, the subject of the confluence and, if applicable, the location of the confluence. The invites to the confluence may also be messages including the details of the confluence. For example, the invites may be emails, instant messages or text messages including the details of the confluence.

At step 390, resources may be allocated for the confluence. Resources may be allocated in a manner similar to that described in relation to step 230 of the example method 200 of FIG. 2.

Preferred Time Period Identification Method

FIG. 4 illustrates a method 400 for identifying a preferred time period of one or more time period options according to an embodiment. The method 400 may be performed as part of the scheduling method 300 of FIG. 3. The method 400 may be implemented as one or more computer-executable instructions executed on one or more computing devices, e.g. the computing device 500 described in relation to FIG. 5. The method 400 may be performed by the application server side runtime 140 and/or the confluence scheduling engine 190 described with respect to FIG. 1. Optional steps are indicated via dashed lines.

At step 410, it is determined whether there is a single time period option, e.g. whether the one or more time period options consist of only one time period option. If there is a single time period option then the single time period is plainly the preferred time period. Hence, if it is determined that there is a single time period option, step 412 is performed which identifies the single time period as the preferred time period.

At step 420, at least a subset of the time period options are sent to client devices of one or more attendee entities based on the availability and importance of the one or more attendee entities.

The importance of an entity may include indications as to whether the attendance of an entity is optional or required and/or whether an entity is a VIP. The at least a subset of the time period options may be sent to required and/or VIP entities first. This may allow those of the time period options where the required and/or VIP entities are not available to be excluded from a subset of the time period options sent to the client devices of optional attendee entities.

Alternatively or additionally, the at least a subset of the time period options sent to required entities may be larger than the subset of time period options presented to optional entities. For example, there may be one or more of the time period options that the host entity has indicated are possible but undesirable and/or entity preference data indicates are undesirable to at least one of the attendee entities, but at which the at least of one of the attendee entities is expected to be available. These one or more undesirable time period options may be sent to required entities but not to optional attendee entities, as, if the only time period(s) at which the required entities are available are in these one or more undesirable time period options then this may override their undesirableness while the availability of an optional attendee would not.

Alternatively or additionally, the at least a subset of the time period options sent to VIP entities may be larger than the subset of time period options presented to other entities. For example, there may be one or more time period options that the host entity has indicated are feasible but undesirable and/or entity preference data indicates are undesirable, e.g. one or more time period options before and/or after regular working hours. These one or more time period options may not be sent to others of the entities but may be sent to VIP entities, as the attendance of the VIP entities at the confluence may be paramount and their availability may be limited.

At step 430, respective selections of one or more of the at least a subset of the time period options are received from the client devices of the one or more attendee entities. Each selection includes indications as to which of the at least a subset of the time period options the respective entity is available based on input from the respective entity. The selection may be binary, e.g. the entity may indicate that they are either available or unavailable at each of the time periods, or the selection may indicate a ‘degree of availability’ for each of the time periods. For example, in addition to simply indicating whether they are available or unavailable at a time period, it may be possible for a respective entity to indicate that they are not currently available at the time period but could make themselves available if necessary and/or to indicate that they are available but have a strong preference against the time period.

Step 430 may also include receiving suggestions for one or more different time period options from the client devices of the one or more attendee entities. For example, an entity may indicate that they are unavailable at all of the time period options and submit one or more suggestions of new time period options where they are available. These new time period option suggestions may be submitted through an interactive process whereby the entity is restricted from submitting suggestions for time period options where at least one required entity is known to be unavailable. The use of such an interactive process may be available through an application-specific web or native client interface to entities whose organisations have implementations of the confluence-resource-allocation systems described herein. The use of such an interface may not be available to other entities, e.g. external attendee entities of the confluence. These other entities may make ad hoc suggestions of one or more time period options.

At step 440, it is determined whether an optimal time period option is identifiable based on the selection. An optimal time period may be identifiable if there is a single time period at which at least the required attendee entities are available. An optimal time period may also be identifiable if there are multiple time periods where the required attendee entities are available but one of these multiple time periods is clearly preferable. One of these multiple time periods may be clearly preferable for any or any combination of the following reasons: more of the optional attendee entities are available; the preferences of entities as derived from entity preference data and/or from the received selections, e.g. indications of degrees of availability, may indicate that there is a time period that most or all of the entities prefer; and/or preferred confluence equipment and/or confluence locations are available at one of the time periods but not at others of the time periods. An optimal time period may not be identifiable if there is no time period option for which the required entities are available. An optimal time period option may also not be identifiable where there are a plurality of viable time period options. However, in some implementations, one of the plurality of viable time period options may be arbitrarily identified as the optimal time period option. For example, a random one of the plurality of equally viable time period options may be identified as the optimal time period option.

In some implementations, an optimal time period option may be identified even where there is no time period option at which all of the required entities are available. In these situations, while each of the time period options may be disruptive to some extent (e.g. by clashing with another scheduled event for one or more of the entities), the optimal time period option may be identified as the least disruptive of time the period options. To determine which of the time period options is least disruptive, a disruption value may be calculated for each of the time period options. The optimal time period option may be determined as the time period having the lowest disruption value.

The disruption value may be calculated based on one or more factors pertaining to any or any combination of the entities, the availability of the entities and conflicting confluences or other commitments causing the one or more entities to be unavailable. The calculation of the disruption value may be based on the importance of an unavailable one or more entities to the confluence, e.g. whether each of the unavailable one or more entities are considered a VIP, required or optional for the confluence. The calculation of the disruption value may also be based on the importance of the unavailable one or more entities to the conflicting confluence(s) or other commitment(s), e.g. whether each of the one or more entities are considered a VIP, required or optional for the conflicting confluence. For example, if an unavailable entity is considered to be mandatory to the confluence but optional to the conflicting confluence then the disruption value will be lower than if the entity were considered mandatory to the conflicting confluence. The calculation of the disruption value may also be based on whether the conflicting confluence is a recurring confluence. For example, if the conflicting confluence is a daily meeting, e.g. a daily stand-up, then the disruption value may be lower as it may be that missing a single occurrence of a recurrent confluence is less disruptive than missing a one-off meeting. The disruption value may also be calculated based on the number of entities at the conflicting confluence. For example, if the conflicting confluence is a single person confluence involving only one of the unavailable entities, e.g. thinking time for the one of the unavailable entities, or a one-on-one confluence between one of the unavailable entities then the calculated disruption value may be lower than if the conflicting confluence were one involving several entities. The disruption value may also be calculated based on the hierarchical position, e.g. the seniority, of the entities involved in the conflicting confluence, with a higher disruption value calculated if the conflicting confluence involves more senior entities, e.g. senior management.

Such disruption values may be calculated even where an optimal time period option is not identifiable, e.g. where none of the time period options have below a threshold disruption value, and the disruption values, information on which they are based and/or information derived therefrom provided to the client device of the host entity for analysis in step 450.

An optimal time period option may be identifiable where there a plurality of viable time period options. In these situations, the optimal time period option may be identified as the most desirable of the time period options. To determine which of the time period options is most desired, a desirability value may be calculated for each of the time period options. The optimal time period option may be determined as the time period option having the greatest desirability value.

The desirability value may be calculated based on one or more factors pertaining to any or any combination of the entities, the time of the time period option, and resources to be allocated for the confluence. The desirability value may be a value which is or is based on a function, e.g. a weighted sum, of per entity desirability weights for a given time period option. The function may weight the per entity desirability weights based on the importance of the respective entity. The per entity desirability weights may be based on expected working hours for the entity. Time period options that come before or shortly after the expected working hours of the entity may be given a lower desirability weight then those fully within the expected working hours. Time period options fully within but close to a start or end of the expected working hours may also be given a lower desirability weight due to, respectively, a likely need for the entity to prepare for a confluence and a possibility of a confluence overrunning. For example for an entity with expected working hours of 09:00-17:00, with all other things being equal, a time period option of 08:30-09:00 may be given a low desirability weight, the time period option of 09:00-09:30 may be given a slightly higher but not maximum desirability weight, and times from 10:00-12:00 given a maximum desirability weights. The profile over time of desirability weights for a given entity may be constructed through analysis of a variety of inputs that can include but are not limited to: expected working hours, usual lunch break hours, and working patterns dependent on the day of the week. The desirability weights may additionally or alternatively be based on other confluences of the entity on 09:00 to 11:00, but with no confluences in the afternoon, the time range 14:00-16:00 will have a higher desirability weight than the 11:00-14:00 range. The desirability weight may be further based on the proximity of the (suggested) location of the confluence with the location(s) of other confluence(s) for the entity. For example, a time period option which is immediately adjacent in time with another confluence for the entity, but in a location that is in a different building to the (suggested) location will be marked as less desirable than a time period option that would allow for travel time between locations.

The desirability value may additionally or alternatively be calculated based on resources (e.g. locations) allocated to or to be allocated to the confluence. The contribution of these the calculation of the desirability value may be based on configured parameters and/or rules. The rules and/or parameters may be based on environmental factors, e.g. sun exposure may meant that a precise confluence location, such as a meeting room, can get uncomfortably hot in the afternoon. The rules and/or parameters may be based on other confluences scheduled at or near the same location at times proximate to the time period options. For example, the time period option immediately adjacent to a confluence with a large number of attendees may be marked as less desirable than a later time period option that would allow for the room to be aired out and/or the air conditioning used to bring the room to a more comfortable temperature). The rules and/or parameters may be based on energy consumption reduction factors. For example, in smart buildings, air conditioning may be activated or deactivated based on whether presence is detected or expected in a precise confluence location. In this case, the desirability values may be higher for time period options immediately adjacent to other confluences at the same precise confluence location than time period options that are isolated. As in the case of isolated time period options, a temperature control system would have to bring the room to temperature for the confluence instead of maintaining a temperature level already established by adjacent confluences.

Such desirability values may be calculated even where an optimal time period option is not identifiable, e.g. where the difference in the desirability value for a highest and second highest is not greater than an automatic selection threshold, and the desirability values, information on which they are based and/or information derived therefrom provided to the client device of the host entity for analysis in step 450.

Step 442 is performed if an optimal time period option has been determined to be identifiable in step 440. At step 442, the optimal time period is identified as the preferred time period.

Step 450 is performed if an optimal time period has been determined not to be identifiable in step 440. At step 450, the selection(s) of the one or more of the at least a subset of the time period options received from the client devices of the one or more attendee entities are sent to the client device of the host entity. These selections may be displayed to the host entity by their client device for analysis by the host entity. Step 450 may also include sending, to the client device of the host entity, suggestions for one or more time period options received from the client devices of attendee entities.

At step 460, a response to the sent selection(s) of the one or more of the at least a subset of the time period options is received from the host entity. This response may indicate one or more amendments to the time period options or a chosen time period option.

At step 470, it is determined whether the response received from the client device of the host entity indicates any amendments to the time period options, e.g. removals, changes and/or additions to the time period options. If it is determined that the response includes one or more amendments, a step 472 is performed. At step 472, the time period options are amended based on the amendments indicated by the response then execution is returned to step 420.

The amendments to the time period options received may be based on the suggestions received from the client devices of one or more attendee entities. These suggestions may be analysed by the host entity who may amend the time period options to include one or more of the suggestions, e.g. one or more of the suggestions where the host entity expects it is most likely that the required entities are available. In some implementations, amendments to time period options may be performed automatically based on suggestions from one or more of the attendee entities, e.g. without input from the host entity.

Execution continues to step 480 if it is determined that the response does not indicate amendments to the time period options. At step 480, it is determined whether the response received from the client device of the host entity indicates a chosen time period option. For example, there may have been several equally viable time period options identifiable based on the selections and the host entity may have chosen one of these viable time period options.

If a time period is chosen, then the chosen time period is identified as the preferred time period at step 490. If no time period is chosen, then execution is returned to step 420.

It should be noted that whilst the above methods show steps in a certain order, these steps may be rearranged whilst achieving the same overall functionality. For instance, in method 400 of FIG. 4, the order of steps 470 and 480 may be swapped, with step 470 being executed if no time period is chosen.

Computing Device

FIG. 5 shows a computing device 500 using which the embodiments described herein may be implemented.

The computing device 500 includes a bus 510, a processor 520, a memory 530, a persistent storage device 540, an Input/Output (I/O) interface 550, and a network interface 560.

The bus 510 interconnects the components of the computing device 500. The bus may be any circuitry suitable for interconnecting the components of the computing device 500. For example, where the computing device 500 is a desktop or laptop computer, the bus 510 may be an internal bus located on a computer motherboard of the computing device. As another example, where the computing device 500 is a smartphone or tablet, the bus 510 may be a global bus of a system on a chip (SoC).

The processor 520 is a processing device configured to perform computer-executable instructions loaded from the memory 530. Prior to and/or during the performance of computer-executable instructions, the processor may load computer-executable instructions over the bus from the memory 530 into one or more caches and/or one or more registers of the processor. The processor 520 may be a central processing unit with a suitable computer architecture, e.g. an x86-64 or ARM architecture. The processor 520 may include or alternatively be specialised hardware adapted for application-specific operations.

The memory 530 is configured to store instructions and data for utilization by the processor 520. The memory 530 may be a non-transitory volatile memory device, such as a random access memory (RAM) device. In response to one or more operations by the processor, instructions and/or data may be loaded into the memory 530 from the persistent storage device 540 over the bus, in preparation for one or more operations by the processor utilising these instructions and/or data.

The persistent storage device 540 is a non-transitory non-volatile storage device, such as a flash memory, a solid state disk (SSD), or a hard disk drive (HDD). A non-volatile storage device maintains data stored on the storage device after power has been lost. The persistent storage device 540 may have a significantly greater access latency and lower bandwidth than the memory 530, e.g. it may take significantly longer to read and write data to/from the persistent storage device 540 than to/from the memory 530. However, the persistent storage 540 may have a significantly greater storage capacity than the memory 530.

The I/O interface 550 facilitates connections between the computing device and external peripherals. The I/O interface 550 may receive signals from a given external peripheral, e.g. a keyboard or mouse, convert them into a format intelligible by the processor 520 and relay them onto the bus for processing by the processor 520. The I/O interface 550 may also receive signals from the processor 520 and/or data from the memory 530, convert them into a format intelligible by a given external peripheral, e.g. a printer or display, and relay them to the given external peripheral.

The network interface 560 facilitates connections between the computing device and one or more other computing devices over a network. For example, the network interface 560 may be an Ethernet network interface, a Wi-Fi network interface, or a cellular network interface.

Implementations of the subject matter and the operations described in this specification can be realized in digital electronic circuitry, or in computer software, firmware, or hardware, including the structures disclosed in this specification and their structural equivalents, or in combinations of one or more of them. For instance, hardware may include processors, microprocessors, electronic circuitry, electronic components, integrated circuits, etc. Implementations of the subject matter described in this specification can be realized using one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

While certain arrangements have been described, the arrangements have been presented by way of example only, and are not intended to limit the scope of protection. The inventive concepts described herein may be implemented in a variety of other forms. In addition, various omissions, substitutions and changes to the specific implementations described herein may be made without departing from the scope of protection defined in the following claims.

1. A computer-implemented method comprising:
receiving a request to schedule a confluence involving a plurality of entities during a future time interval, wherein the confluence is associated with one or more confluence locations;
obtaining a plurality of expected location indicators, wherein the plurality of expected location indicators indicate the expected location of the plurality of entities during the future time interval; and
allocating resources for the confluence during the future time interval based on the plurality of expected location indicators.

2. The method of claim 1, wherein allocating resources for the confluence comprises:
determining a future time period for the confluence within the future time interval.

3. The method of claim 2, wherein determining the future time period for the confluence comprises:
determining one or more suggested future time periods for the confluence within the future time interval; and
sending, to a client device of a host entity of the plurality of entities, the one or more suggested future time periods.

4. The method of claim 3, wherein the one or more suggested future time periods are determined based on an availability of one or more of the plurality of entities within the future time interval.

5. The method of claim 3, wherein the one or more suggested future time periods are determined based on an importance of one or more of the plurality of entities.

6. The method of claim 3, wherein the one or more suggested future time periods for the confluence comprise the future time period, and wherein determining the future time period for the confluence comprises:
receiving, from the client device of the host entity, a selection of the future time period from the one or more suggested future time periods.

7. The method of claim 3, wherein determining the future time period for the confluence comprises:
receiving, from the client device of the host entity, a selection of the one or more suggested future time periods as a plurality of time period options;
sending, to the client devices of one or more attendee entities, at least a subset of the plurality of time period options; and
receiving, from at least one of the client devices of the one or more attendee entities, selections of one or more of the at least a subset of the plurality of time period options.

8. The method of claim 7, wherein the at least a subset of the plurality of time period options sent to the client device of a respective entity is based on an importance of the respective entity.

9. The method of claim 7, wherein the time period options comprise the future time period, and wherein determining the future time period for the confluence comprises:
determining, based on the selections of the one or more of the at least a subset of the plurality of time period options, that the future time period is a best time period of the plurality of time period options.

10. The method of claim 7, wherein determining the future time period for the confluence comprises:
sending, to the client device of the host entity, the selections of the one or more of the at least a subset of the plurality of time period options; and
receiving, from the client device of the host entity, one or more amended time period options, wherein the one or more amended time period options comprise the future time period.

11. The method of claim 2, wherein allocating resources for the confluence comprises:
allocating, at the future time period, a precise confluence location for the confluence within a general confluence location of the one or more confluence locations.

12. The method of claim 11, wherein allocating the precise confluence location comprises:
determining, based on the plurality of expected location indicators, the number of the plurality of entities that are expected to be proximate to the general confluence location at the future time period;
allocating, at the future time period, the precise confluence location based on the number of the plurality of entities, wherein the precise confluence location has an entity capacity greater than or equal to the number of the plurality of entities.

13. The method of claim 2, wherein allocating resources for the confluence comprises:
allocating equipment for the confluence at the future time period based on the plurality of expected location indicators.

14. The method of claim 13, wherein allocating the equipment for the confluence comprises:
determining, based on the plurality of expected location indicators, that one or more of the plurality of entities are expected to be proximate to at least one of the one or more confluence locations at the future time period; and
allocating equipment for use by at least one of the one or more of the plurality of entities at the at least one of the one or more confluence locations at the future time period.

15. The method of claim 14, wherein allocating the equipment for the confluence comprises:
determining, based on the plurality of expected location indicators, that one or more of the plurality of entities are not expected to be proximate to any of the one or more confluence locations at the future time period; and
allocating equipment facilitating telecommunication with the one or more confluence locations to at least one of the one or more of the plurality of entities at the future time period.

16. The method of claim 2, wherein allocating resources for the confluence comprises:
determining, based on the plurality of expected location indicators, that one or more of the plurality of entities are not expected to be proximate to any of the one or more confluence locations at the future time period; and
in response to determining that the first one or more of the plurality of entities is not expected to be proximate to any of the one or more confluence locations, providing, to the first one or more of the plurality of entities, telecommunication information facilitating telecommunication with the one or more confluence locations.

17. The method of claim 1, further comprising:
obtaining an updated plurality of expected location indicators; and
updating the resource allocation for the confluence during the future time interval based on the updated plurality of expected location indicators.

18. The method of claim 17, wherein a precise confluence location has been allocated for the confluence within a general confluence location of the one or more confluence locations, and wherein updating the resource allocation for the confluence comprises:
determining, based on the updated plurality of expected location indicators, a change in the number of the plurality of entities expected to be proximate to the confluence location; and
allocating a different precise confluence location within the general confluence location for the confluence based on the change in the number of the plurality of entities expected to be proximate to the confluence location.

19. A computing system comprising one or more computing devices, wherein the one or more computing devices comprise one or more processors configured to:
receive a request to schedule a confluence involving a plurality of entities during a future time interval, wherein the confluence is associated with one or more confluence locations;
obtain a plurality of expected location indicators, wherein the plurality of expected location indicators indicate the expected location of the plurality of entities during the future time interval; and
allocate resources for the confluence during the future time interval based on the plurality of expected location indicators.

20. A non-transitory computer-readable medium comprising instructions that, when executed by a processor, cause the processor to:
receive a request to schedule a confluence involving a plurality of entities during a future time interval, wherein the confluence is associated with one or more confluence locations;
obtain a plurality of expected location indicators, wherein the plurality of expected location indicators indicate the expected location of the plurality of entities during the future time interval; and
allocate resources for the confluence during the future time interval based on the plurality of expected location indicator
